(19) United States
(12) Patent Application Publication
(10) Pub. No.: US 2006/0171691 A1
(43) Pub. Date: Aug. 3, 2006

(54) Optical data recording/reproducing device

(75) Inventors: Hajime Kurahashi, Tochigi (JP); Hikaru Shinozaki, Tochigi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: FUJINON SANO CORPORATION, Sano-shi (JP)

(21) Appl. No.: 11/340,554

(22) Filed: Jan. 27, 2006

(30) Foreign Application Priority Data
Jan. 31, 2005 (JP) 2005-022467

(51) Int. Cl. H01C 10/16; H04N 5/85

(52) U.S. Cl. 386/126; 338/126

(57) ABSTRACT

An optical data recording/reproducing device including a light source adapted to project a laser beam containing s-polarized light as a major component along with a minor proportion of p-polarized light, a polarizing beam splitter located in a light path of said laser beam for mainly transmitting p-polarized light and reflecting off s-polarized light, an APC photosensor element located in a position for receiving transmitted p-polarized light from said polarizing beam splitter for detection of light intensity, and a data recording and reproducing photosensor element located in a position for receiving return light of s-polarized light reflected off toward an optical disc surface by said polarizing beam splitter.

### BACKGROUND OF THE INVENTION

1. Field of the Art

This invention relates to An optical data recording/reproducing device.

2. Prior Art

Devices (optical pickups) for recording and reproducing data on optical discs such as CD (compact disc) and DVD (digital versatile disc) are largely arranged to collimate a laser beam from a light source by the use of a collimator lens, and split the laser beam in two by the use of a polarizing beam splitter. One laser beam from the polarizing beam splitter is converged on an optical disc after conversion from linearly polarized light to circularly polarized light by the use of a ¼ phase plate. Reflected light off the optical disc is converted again to linearly polarized light by the ¼ phase plate and, after being passed through the polarizing beam splitter, cast toward a photosensor element (a data recording/reproducing photosensor element) by the use of a condenser lens to detect signals from incident light. The other laser beam which has been separated by the polarizing beam splitter is cast on another photosensor element (an APC photosensor elemen) by the use of a condenser lens for use in adjusting the intensity of the light source laser beam (APC: Auto Power Control).

In this connection, for example, described in Japanese Laid-Open Patent Application 2002-157769 (Patent Literature 1) is an optical system employing a polarizing beam splitter for splitting incident light into a light beam to be directed toward an optical disc and a light beam to be directed toward an APC photosensor element. In this case, a mixed wave light beam of p-polarized light and s-polarized light (with a p-polarized light content in a proportion in excess of 90% and an s-polarized light content in a proportion less than 10%) is projected from a light source toward a polarizing beam splitter which transmits p-polarized light approximately 100% while reflecting s-polarized light approximately 100%, there by directing p-polarized light toward an optical disc and s-polarized light toward an APC photosensor element.

As described in the Patent Literature 1 mentioned above, a polarizing beam splitter transmits approximately 100% of p-polarized light (same as p-polarized wave in the Patent Literature 1) and reflects approximately 100% of s-polarized light (same as s-polarized wave in the Patent Literature 1). That is to say, polarizing beam splitters are unable to transmit or reflect an incident light component perfectly 100%. Namely, a polarizing beam splitter with the above-mentioned polarization characteristics (in reflectivity and transmittance) is a sort of ideal one, and it is the usual case that actually fabricated polarizing beam splitters are more or less degraded in polarization characteristics (are not 100% perfect in polarization characteristics). Especially, there is a trend toward degradation in transmittance of p-polarized light.

Generally, polarizing beam splitters are stable in reflectivity of s-polarized light. On the other hand, characteristics in transmittance of p-polarized light are relatively instable. These trends are seen in spectral curves of polarization characteristics, that is, a spectral curve of s-polarized light reflectivity is in a stably flat shape, in contrast to a spectral curve of p-polarized light transmittance which contains the so-called ripples arising from instable characteristics. It is extremely difficult to fabricate a polarizing beam splitter with 100% p-polarized light transmittance at a satisfactory yield. For these reasons, polarizing beam splitters which are actually in use do not have ideal polarization characteristics, and are more or less degraded particularly in transmittance of p-polarized light.

Therefore, in case a laser beam with a large proportion of p-polarized light is projected and transmitted through a polarizing beam splitter to utilize transmitted p-polarized light as a data recording and reproducing laser beam as in Patent Literature 1 mentioned above, one faces a problem of low efficacy of laser light under the influence of degraded transmittance of a polarizing beam splitter. Besides, degradation in transmittance invites another problem that part of p-polarized light is reflected off a polarizing beam splitter instead of being transmitted therethrough. Since p-polarized light is contained in a large proportion, the reflected part of p-polarized light can detrimentally disturb the power control by an APC photosensor element, making it difficult to supply a laser beam from a light source in a stabilized state. Especially, in the case of a polarizing beam splitter which is adapted to cope two with different wavelengths instead of a single wavelength or in the case of a polarizing beam splitter which has recently come into use to cope with three different wavelengths, it is extremely difficult to strictly control the transmittance of p-polarized light at a specified wavelength.

Generally, it is known that wavelength of laser light which is projected from a light source changes under the influence of variations in temperature. That is, in the case of p-polarized light which contains ripples in the spectral curve, a change of wavelength which is caused by a temperature variation can affect transmittance of a polarizing beam splitter. Therefore, in case p-polarized light is utilized for a laser beam in recording and reproducing data on an optical disc, there always arises a problem of degraded efficiency of laser light.

Further, a space-saving compact construction is required of optical data recording and reproducing devices as represented by the optical pickup described in the Patent Literature 1 mentioned above. Namely, in the case of optical data recording and reproducing devices in general, various component parts are located in such a way as to let a laser beam projected from a light source travel along a light path parallel with a disc surface. In order to finally turn the parallel light path through 90 degrees toward the disc surface, it is essential for the optical pickup to include a turning mirror. Addition of parts exclusively for turning a light path of a laser beam results in a device which is more complicate in construction and large in size as a whole, hampering to achieve the objective of providing a device of space-saving compact construction. Besides, addition of exclusive parts gives rise to other problems such as higher production cost and loss of luminous energy, inevitably caused as a result of the use of a reflector mirror which is not necessary capable of 100% light reflection. Further, adoption of an increased number of parts can be a cause of disturbance of laser light wave surfaces. Furthermore, since each part has to be set in an aligned position relative to an optical axis by high precision adjustments, added parts require additional high precision jobs in aligning and assembling processes. For these reasons, it is not desirable to locate additional parts in a light path of a laser beam.

### SUMMARY OF THE INVENTION

It is an object of the present invention to provide An optical data recording/reproducing device (an optical pickup) which is capable of supplying a laser beam in a stabilized state, suppressing drops in light energy efficacy and permitting to downsize an installation of the device by omission of a turning mirror.

In accordance with the present invention, in order to achieve the above-stated objective, there is provided an optical data recording/reproducing device, comprising: a light source adapted to project a laser beam containing s-polarized light as a major component along with a minor proportion of p-polarized light; a polarizing beam splitter located in a light path of the laser beam from the light source, the polarizing beam splitter having characteristics of mainly transmitting p-polarized light and reflecting off s-polarized light toward a disc surface; an APC photosensor element adapted to receive and detect p-polarized light transmitted through the polarizing beam splitter for use in controlling intensity of the laser beam; and a second photosensor element of data recording/reproducing purposes adapted to receive return light of the s-polarized light from the disc surface for detection of signals.

The above and other objects, features and advantages of the present invention will become apparent from the following particular description of the invention, taken in conjunction with the accompanying drawings which show by way of example some preferred embodiments of the invention. Needless to say, the present invention should not be construed as being limited to particular forms shown in the drawings.

### BRIEF DESCRIPTION OF THE DRAWINGS

In the accompanying drawings:

FIG. 1 is a schematic view of An optical data recording/reproducing device according to the present invention;

FIG. 2 shows a graph of p-polarized light transmittance along with s-polarized light reflectivity of a polarizing beam splitter;

FIG. 3 shows losses of luminous energy in comparative examples employing light sources having p-polarized light and s-polarized light as a major component, respectively;

FIG. 4 shows losses of luminous energy in other comparative examples employing light sources having p-polarized light and s-polarized light as a major component, respectively;

FIG. 5 is a schematic view of An optical data recording/reproducing device in use with a holographic laser;

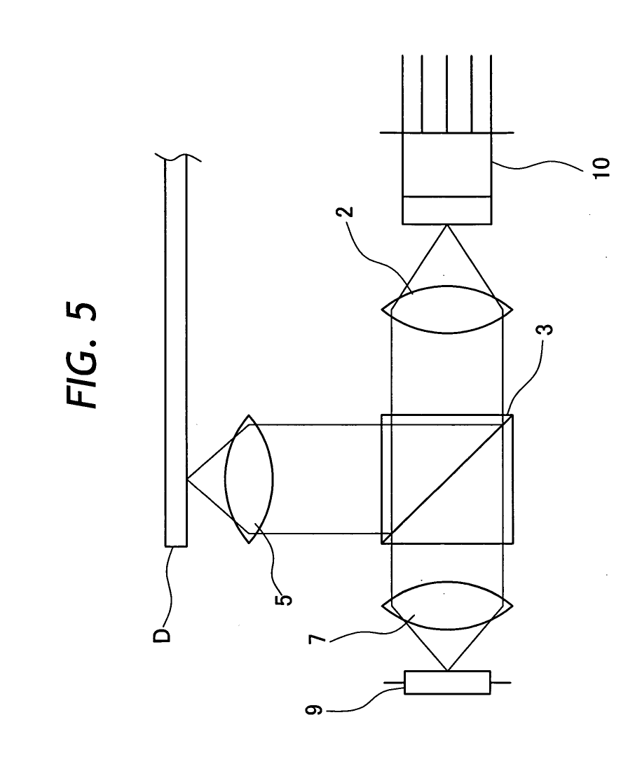

FIG. 6 is a schematic view of An optical data recording/reproducing device without using a collimator lens; and

FIG. 7 is a schematic view of An optical data recording/reproducing device having the holographic laser and polarizing beam splitter of FIG. 6 joined with each other.

### BEST MODE FOR CARRYING OUT THE INVENTION

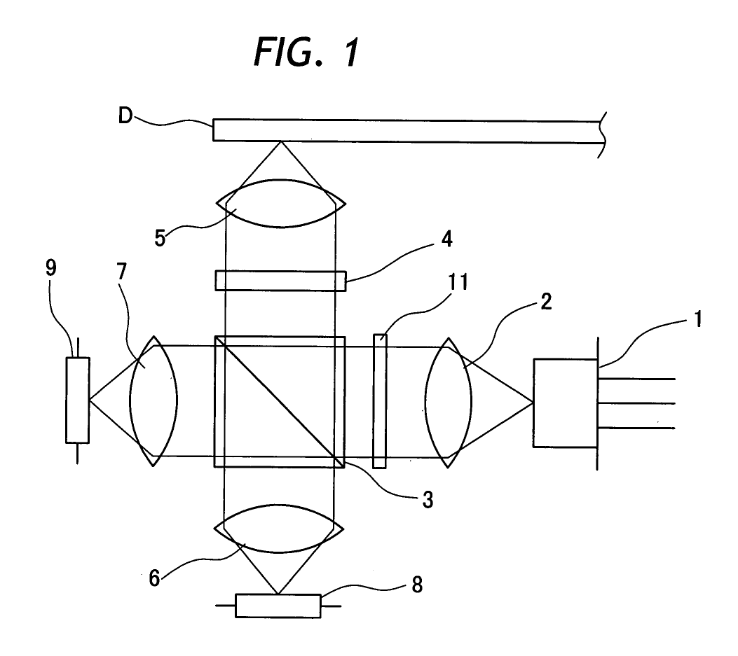

Hereafter, the present invention is described more particularly by way of its preferred embodiments with reference to the accompanying drawings. Referring first to FIG. 1, there is shown An optical data recording/reproducing device according to the present invention, which is largely constituted by a light source 1, collimator lens 2, polarizing beam splitter 3, wave plate 4, objective lens 5, first condenser lens 6, second condenser lens 7, a data recording/reproducing photosensor element 8, an APC photosensor element 9 and a diffraction element 11.

The light source 1 is a light-emitting element which emits a laser beam like a laser diode. In order to have p- and s-polarized components in arbitrary proportions, the light-emitting element of the light source 1 which emits linearly polarized light is rotated about an optical axis through a certain angle in reference to a polarizing beam splitter 3. In this regard, the rotational direction of the light-emitting element may be either clockwise or counterclockwise. Arrangements may be made to rotate a solitary light-emitting element or to rotate a retainer member which retains a light-emitting element. The point is that a laser beam from the light source 1 contains s-polarized light as a major component, along with a predetermined proportion of p-polarized light. In the following description, “a small proportion” is used instead of “a predetermined proportion”. However, the proportion of p-polarized light may be determined arbitrarily as long as it is smaller than that of s-polarized light.

After being collimated by a collimator lens 2, a laser beam from the light source 1 is projected on a diffraction element 11 and thereby diffracted into a O-order light (a main beam) and ±n-order light (a sub-beam). The main beam is used as a recording/reproducing laser beam, while part of the sub-beam is used for tracking. The laser beam leaving the diffraction element 11 is fed to a polarizing beam splitter 3. The position of the diffraction element 11 is not limited to the particular example shown. It can be located in an arbitrary position between the light source 1 and the collimator lens 2, between the polarizing beam splitter 3 and wave plate 4 or between the wave plate 4 and objective lens 5.

The polarizing beam splitter 3 has characteristics to reflect off an s-polarized component of incident laser beam while transmitting a p-polarized component. A laser beam from the light source 1 contains s-polarized light as a major component, along with a small proportion of p-polarized light. Of the laser beam incident on the polarizing beam splitter 3, the major component s-polarized light is reflected off a plane of polarization of the beam splitter 3 while the minor component p-polarized light is transmitted through the polarizing beam splitter 3.

S-polarized light reflected off the polarizing beam splitter 3 is used as signal light for recording and reproducing optical discs, and fed to the wave plate 4 (a ¼ wave plate which convert linearly polarized light to circularly polarized light) for conversion to circularly polarized light. Circularly polarized light is then fed to the objective lens 5 and thereby converged to a predetermined position on an optical disc D. Reflected light off the disc D is returned through the objective lens 5 and converted again from circularly polarized light to linearly polarized light by the wave plate 4. Further, the component which is projected as s-polarized light from the light source 1 is converted to p-polarized light as it is fed back and forth through the wave plate, and fed to the polarizing beam splitter 3. A major part of p-polarized return light is transmitted through the polarizing beam splitter 3 and then fed to the condensing lens 6 and thereby converged on a photosensor element 8 for detection of recording or reproducing signals.

On the other hand, a small proportion of p-polarized light which has been transmitted through the polarizing beam splitter 3 is used as a laser beam for detection and control of light intensity of the light source 1. The p-polarized light is fed to a second condensing lens 7 and thereby converged on an APC photosensor element 9 which detects the intensity of the laser light from the light source 1 and, according to a detected light intensity, controls the output of the light source 1 to an appropriate level.

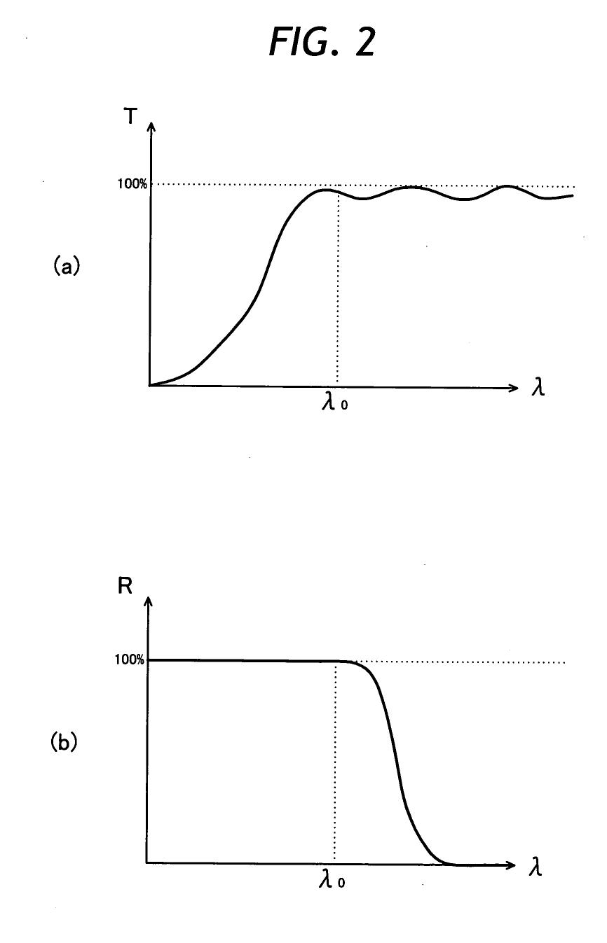

Described above is the basic construction of the optical data recording and reproducing device according to the present invention. As mentioned hereinbefore, it is difficult to obtain a polarizing beam splitter with ideal polarization characteristics, i.e., 100% reflection of s-polarized light and 100% transmission of p-polarized light. In this regard, shown in FIG. 2 is an example of polarization characteristics of the polarizing beam splitter 3 (an example of transmission of p-polarized light and reflection of s-polarized light at wavelength λo). Shown at (a) of FIG. 2 is a graph of p-polarized light transmittance of the polarizing beam splitter 3, and at (b) a graph of s-polarized light reflectivity of the polarizing beam splitter 3. In essence, the polarizing beam splitter 3 is a mirror which reflects incident s-polarized light, and exhibits good characteristics in s-polarized light reflectivity as seen in the graph at FIG. 2(b). However, as seen in the graph at FIG. 2(a), the polarizing beam splitter is instable in p-polarized light transmittance due to existence of ripples. In the present invention, instable p-polarized light is used for detection of light intensity for APC, while using as signal light s-polarized light which is stable in reflectivity.

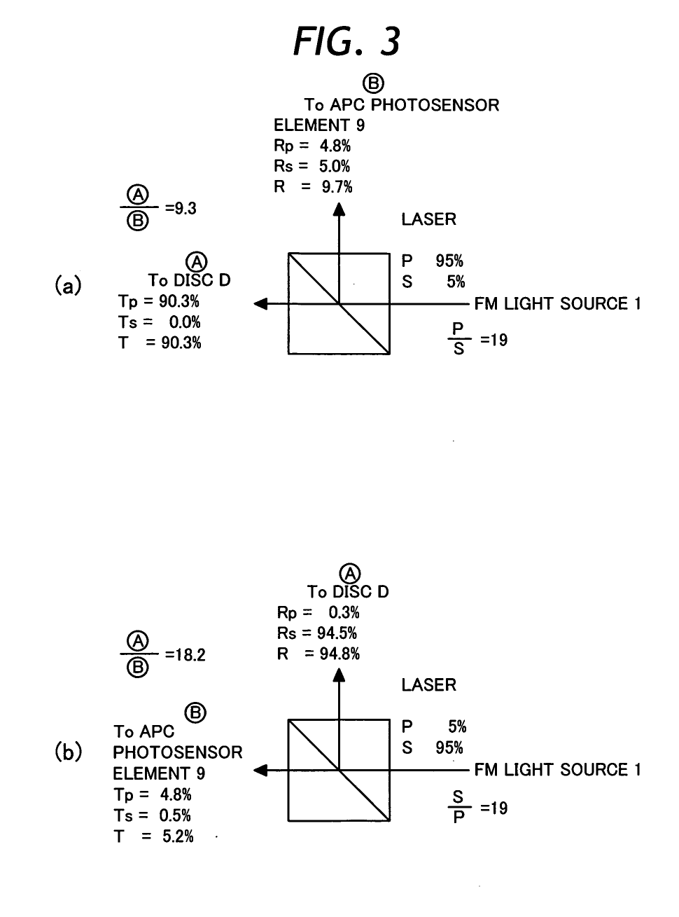

In this connection, shown at FIGS. 3(a) and (b) are comparative examples using as signal light p-polarized light and s-polarized light, respectively. In the case of FIG. 3(a), the proportion of p-polarized light in a laser beam from the light source 1 is 95% and the proportion of s-polarized light is 5%. In the case of FIG. 3(b) to which the present invention is applied, the proportion of p-polarized light is 5% and the proportion of s-polarized light is 95%. The light-emitting element of the light source 1 is rotated through a predetermined angle about an optical axis to project a laser beam having p- and s-polarized components in the required proportions. A common polarizing beam splitter is used in the comparative examples of FIGS. 3(a) and (b), with polarization characteristics which is not ideal, more particularly, with transmittance of 95.0% and reflectivity of 5.0% for p-polarized light and transmittance of 0.5% and reflectivity of 99.5% for s-polarized light. Of course, these numerical figures reflect that the transmittance of p-polarized light is degraded as compared with the reflectivity of s-polarized light as described hereinbefore.

As shown in FIG. 3(a), in order to use p-polarized light as signal light, it is necessary to locate the APC photosensor element 9 on the opposite side of the polarizing beam splitter 3 and to locate a disc D on the transmission side. Namely, generally speaking, the polarizing beam splitter 3 has characteristics of transmitting p-polarized light and reflecting s-polarized light. Therefore, in case p-polarized light is used as signal light, the APC photosensor element 9 and disc D are inevitably located in this way. In this instance, as shown in FIG. 3(a), a rate (Tp) of p-polarized light of a laser beam toward the disc D against the proportion of a p-polarized light component in the laser beam projected from the light source 1 can be calculated by multiplying the proportion of the p-polarized light component in the laser beam from the light source by the transmittance of p-polarized light of the polarizing beam splitter 3 as follows, 0.95 (95%)×0.95 (95%)=0.9025 (90.25%, which is 90.3% after rounding off the decimal second place. Likewise, a rate (Ts) of s-polarized light of a laser beam toward a disc D against the proportion of an s-polarized light component in the laser beam from the light source 1 can be calculated by multiplying the proportion of the s-polarized light in the laser beam from the light source by the transmittance of s-polarized light of the polarizing beam splitter 3 as follows, 0.05 (5%)×0.005 (0.5%)=0.00025 (0.025%), which is 0.0% after rounding off the decimal second place. Thus, as a whole the rate of the laser light (T) which is fed toward a disc D is 90.3+0.0=90.3%. It is desirable to use entire p-polarized light as laser light toward a disc D but in the case of FIG. 3(a) it is reduced by 4.7% from 95.0% to 90.3%. Shown in the drawing is a rate of p-polarized light to the APC photosensor element 9, and a quantity of reflected s-polarized light as well. A rate (Rp) of reflected p-polarized light is 4,8% and a rate (Rs) of reflected s-polarized light is 5.0%. That is, laser light (R) is fed to the APC photosensor element 9 substantially at a rate of 9,7%.

In this instance, the laser beam projected from the light source 1 contains p- and s-polarized light in a rtaio of 95%: 5%=19:1. The laser light to the disc D and the laser light to the APC photosensor element 9 are in a ratio of 90.3%: 9.7%≈9.3:1. That is to say, the rates before and after the polarizing beam splitter 3 are not preserved. Therefore, it becomes necessary for an APC system of FIG. 3(a) to employ a polarizing beam splitter which is at least almost ideal in polarization characteristics.

On the other hand, shown in FIG. 3(b) is an optical system according to the present invention, employing s-polarized light for a data recording/reproducing laser beam. In FIG. 3(B), a laser beam which is projected from the light source contains p-polarized light in a proportion of 5% and s-polarized light in a proportion of 95%. At the polarizing beam splitter 3, p-polarized light is reflected off at a rate (Rp), which is 0.05 (5%)×0.05 (5%)=0.0025 (0.25%) and which is 0.3 after rounding off the decimal second place. On the other hand, a rate (Ps) of reflected s-polarized light is 0.95 (95%)×0.995 (99.5%)=0.94525 (94.525%), which is 94.5% after rounding off the decimal second place. Reflected light (R) is fed to the disc D at a rate of 94.5+0.3=94.8 as a whole. In using all of s-polarized light for the laser beam (R) toward the disc D, the efficacy rate drops from 95% to 94.8 in the case of the system of FIG. 3(b), a small drop of only 0.2%. Also shown in the drawing are rates (Tp) and (Ts) of transmitted p- and s-polarized light in the laser beam toward the APC photosensor element 9, which are 4.8% and 0.5%, respectively, and 5.3% after rounding off the decimal second place. Thus, substantially 5.2% of laser light is directed toward the APC photosensor element 9.

At this time, a laser light from the light source contains s-polarized and p-polarized light components in a ratio of 95%: 5%=19:1 but a laser light toward the APC photosensor element 9 contains these components in a ratio of 94.8%: 5.2%≈18.2:1. Thus, almost the same rates are preserved before and after the polarizing beam splitter. This means that, as compared with the system of FIG. 3(a), the system of FIG. 3(b) can realize better energy distribution even by the use of an actually available polarizing beam splitter.

On the other hand, laser light transmitted through the polarizing beam splitter 3 is projected on the APC photosensor element 9 to control the laser light intensity. Although the intensity is detected by way of p-polarized light which is instable in transmitting characteristics, p-polarized light is contained only in a minor proportion in the laser beam from the light source 1 which contains s-polarized light as a major component. Therefore, should there be a certain drop in transmittance of p-polarized light by the polarizing beam splitter 3, actually it would not pose adverse effects on APC to any material degree because the proportion of p-polarized light is very small from the beginning. For example, in the case of FIG. 3(b), even if transmittance of p-polarized light drops to “95.0%”, such a drop is ignorably small from the original content of p-polarized light which is as small as 5%, and can be substantially absorbed by the system to provide stable APC.

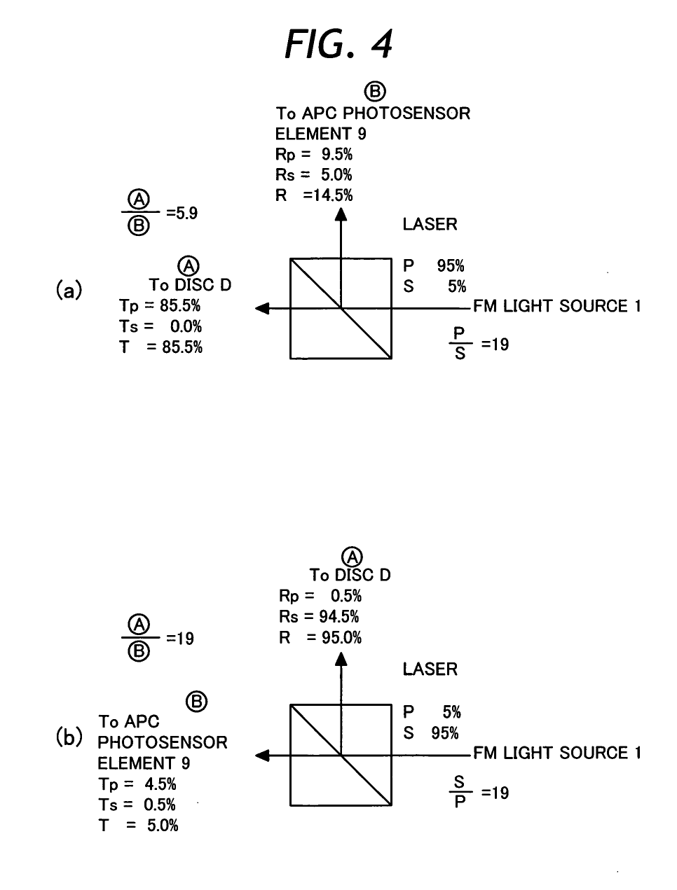

Shown at FIGS. 4(a) and (b) are examples in which the polarizing beam splitter 3 is degraded in polarization characteristics as compared with the counterpart in FIG. 3. Namely, the polarizing beam splitter 3 which is applied in FIG. 4 is 90.0% and 10.0% in p-polarized light transmittance and reflectivity, respectively, and 0.5% and 99.5% in s-polarized light transmittance and reflectivity, respectively. As shown in FIGS. 4(a) and (b), the laser light efficacy of the system is 85.50% when p-polarized light is employed as signal light, and 95.0% when s-polarized light is employed as signal light. Considering output to input ratio, when an input laser beam incident on the polarizing beam splitter contains p- and s-polarized light in a ratio of 19:1, the ratio of transmitted light and reflected light on the output side of the polarizing beam splitter 3 is 5.9:1 in the case of the p-polarized light transmission system of FIG. 4(a). In this case, ratios before and after the polarizing beam splitter 3 are not preserved, so that, for accurate APC, it becomes necessary to use a polarizing beam splitter which is as ideal as possible in polarization characteristics. In contrast, in the case of the s-polarized light reflection system of FIG. 4(b), the ratio is 19:1 and substantially the same ratio is preserved before and after the polarizing beam splitter 3. Thus, in this case, better energy distribution can be realized as compared with the system of FIG. 3. Namely, since accurate APC is feasible despite a drop in polarization characteristics of the polarizing beam splitter 3, the split system of the invention using s-polarized light as signal light is advantageous and superior to a system using p-polarized light as signal light.

Of course, as signal light, there is no difference between p-polarized light and s-polarized light in an ideal case where transmittance of p-polarized light equivalently matches reflectivity of s-polarized light. However, as described above, due to intrinsic polarization characteristics of existing polarizing beam splitters, p-polarized light is fluctuant in transmittance while s-polarized light is stable in reflectivity. Therefore, as a matter of fact, there is no possibility of transmittance of p-polarized light constantly staying at the same rate as reflectivity of s-polarized light. Besides, transmittance of p-polarized light is fluctuated to a considerable degree by variations in ambient temperature and humidity and also by variations in the environment in use. According to the present invention, by employing as signal light s-polarized light which is stable in reflectivity, it becomes possible to obtain a stable light volume, free of fluctuations which would otherwise be caused by drops in polarization characteristics of the polarizing beam splitter 3.

As mentioned above, according to the present invention, s-polarized light which is reflected off by the polarizing beam splitter 3 is used as signal light. Therefore, a light path which runs from the light source 1 parallel with a surface of an optical disc D can be turned through 90 degrees by the polarizing beam splitter 3 and directed toward the optical disc D. In case p-polarized light is employed as signal light, p-polarized light is transmitted through the polarizing beam splitter 3, so that it is inevitable to provide a turning mirror in a light path downstream of the polarizing beam splitter 3 for turning the laser light path through 90 degrees toward the optical disc surface. The addition of a turning mirror (exclusively for turning the laser light path) 9 results in a pickup device which is enlarged in size as a whole and increased in cost by addition of exclusive parts. Besides, losses of light energy occur more or less at the turning mirror in addition to disturbance of wave surfaces, so that addition of a turning mirror is not desirable from the standpoint of light energy efficacy. Furthermore, as mentioned hereinbefore, addition of a turning mirror requires additional precision work for aligning its optical axis with other component parts and an additional assembling process for the turning mirror.

As mentioned hereinbefore, according to the present invention, s-polarized signal light to the polarizing beam splitter 3 is directly reflected toward an optical disc D by the latter, instead of turning a light path exclusively by the use a turning mirror which requires addition of an increased number of parts which can be a cause unnecessary losses of light energy. Thus, the light path can be turned without using an increased number of parts which might cause disturbance of wave surfaces of the laser beam. In addition, the fabrication process can be simplified because it does not involve precision alignment and assembling work for a turning mirror.

As described above, the optical data recording/reproducing device according to the present invention employs as signal light a laser beam from a light source which contains s-polarized light as a major component, to realize high efficacy of light energy and stabilized APC without influenced by drops in polarization characteristics, particularly in p-polarized light transmittance of a polarizing beam splitter. The use of s-polarized light as signal light which is reflected off the polarizing beam splitter makes it unnecessary to use a turning mirror or the like and contributes to prevent unnecessary light energy losses and to provide the optical data recording/reproducing device in a space-saving compact form as a whole.

Especially in a case where the polarizing beam splitter is of one wavelength alone, almost ideal p-polarized light transmittance can be obtained by deposition of a high-precision polarizing coating. However, in a case where one polarizing beam splitter is used commonly for CD of 780 nm wavelength and DVD of 650 nm wavelength, it is extremely difficult to get p-polarized light transmittance which is akin to an ideal value. It follows that losses of light energy can be suppressed by using more stable s-polarized light as signal light in a case where a single polarizing beam splitter is used at multiple different wavelengths. In such a case, the polarizing beam splitter should have satisfactory characteristics at and around 400 nm, at and around 650 nm and at and around 780 nm. The expression “around” a wavelength range of 30 nm over and under (±30 nm) each operating wavelength (400 nm, 650 nm or 780 nm). However, it is to be understood that the present invention is not limited to these exemplary ranges and can be similarly applied to a case where the operative over and under wavelength ranges are broader than 30 nm. The present invention is not limited to CD, DVD and 400 nm laser beams exemplified above, and can be similarly applied to any arbitrary wavelength.

Furthermore, the optical data recording/reproducing device according to the present invention has operational effects as follows. In case a polarizing beam splitter is a prism type, a polarizing layer and a cementing layer exist internally of the polarizing beam splitter. At the time a laser beam incident on the polarizing beam splitter passes through the cementing layer, variations in transmittance and reflectivity take place due to the so-called ringing phenomenon. Therefore, in case transmitting p-polarized light is employed as signal light, it is inevitably affected by the ringing phenomenon as it passes the cementing layer. However, in case reflecting s-polarized light is employed as signal light, it is free from adverse effects of the ringing phenomenon if reflected off a polarizing layer anterior to a cementing layer. At this time, a slight proportion of p-polarized light is affected by the ringing phenomenon as it is transmitted toward an APC photosensor element. However, the proportion of transmitting p-polarized light is very small, affects of the ringing phenomenon can be ignorable.

In FIG. 1, p-polarized light is turned through 90 degrees as it is reflected off the polarizing beam splitter 3. However, the present invention is not limited to the particular example shown. For example, there may be employed a polarizing beam splitter with a different angle of reflection.

Further, in addition to the optical pickup system shown in FIG. 1, the present invention can be applied to a holographic laser light source 10 consisting of an integral assembly of a light emitting element for projecting a laser beam, a diffraction element (hologram) for diffraction of return light from an optical disc D, and a photosensor element for detection of data signals. In the case of an optical data recording/reproducing device using a holographic laser light source 10, no wave plate is provided for converting reflected s-polarized from the polarizing beam splitter 3 into circularly polarized light. Therefore, return light from a disc D is turned again through 90 degrees by the polarizing beam splitter 3 and directed toward a collimator lens 2. Then, return light is diffracted by the diffraction element of the holographic laser light source 10 and turned toward a data recording/reproducing photosensor element. Thus, by incorporating the data recording/reproducing photosensor element into the holographic laser light source 10, it becomes possible to reduce the number of component parts and to downsize the pickup device as a whole because a wave plate and a diffraction element are unnecessary in this case.

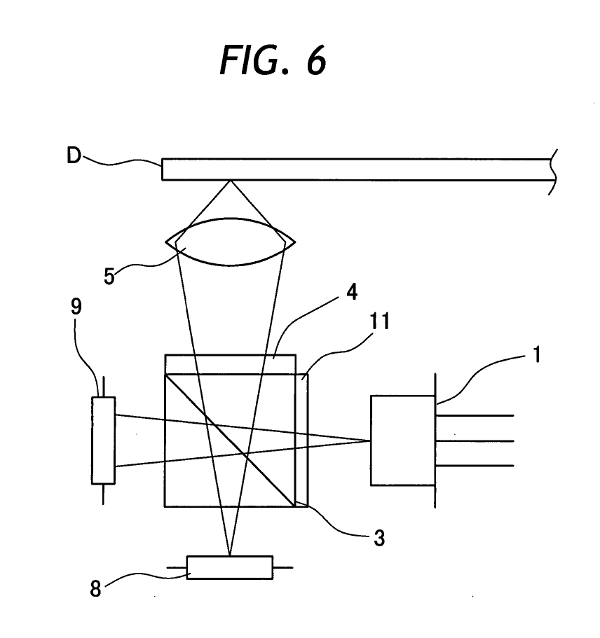

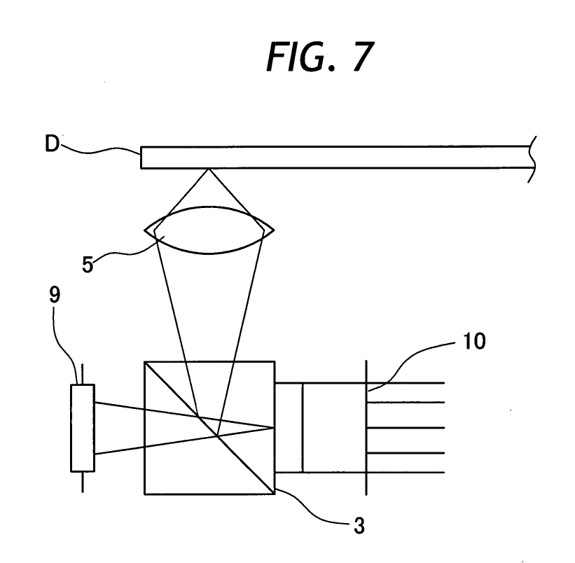

Further, since the present invention can absorb fluctuations in characteristics of a polarizing beam splitter which is dependent on the angle of incidence, there may be employed an arrangement as shown in FIG. 6, omitting the collimator lens 2 which is not essential component here. Omission of the collimator lens 2 makes it possible to further reduce the installation space and production cost the pickup device. Alternatively, as shown in FIG. 7, the polarizing beam splitter 3 may be used in assembly with a holographic laser light source 10 which has a light source 10 and a data recording and reproducing photosensor element 8 assembled as one integral unit. In this case, the disc recording/reproducing device can be constituted by a minimum number of component parts, including the holographic laser light source 10, polarizing beam splitter 3, objective lens 5, APC photosensor element 9, permitting further reductions in installation space and production cost.

In this instance, the holographic laser light source 10 and the polarizing beam splitter 3 can be assembled as one integral unit. Diameter of the laser beam diverges in case the collimator lens 2 is omitted, so that the length of light path should be as short as possible. To this end, it is desirable for the holographic laser light source 10 and the polarizing beam splitter 3 to be joined into one integral unit. In this case, it becomes possible to downsize the polarizing beam splitter 3 and to suppress degradations of wave surfaces because the diameter of the laser beam incident on the polarizing beam splitter 3 can be reduced to a minimum. Of course, there is no need for inseparably joining the holographic laser light source 10 with the polarizing beam splitter 3. Preferably, the two joined component parts are separable from each other at the time of inspection or a repair work.

The above-described polarizing beam splitter 3 is not limited to a prism type and can be a single plate type polarizing beam splitter having a polarizing coating deposited on a glass substrate.

As described above, the optical data recording/reproducing device according to the present invention makes it possible to prevent drops in efficacy of light energy and to control the intensity of a laser beam in a stabilized manner, while saving installation space of the device.

What is claimed is:

1. An optical data recording/reproducing device, comprising:
a light source adapted to project a laser beam containing s-polarized light as a major component along with a minor proportion of p-polarized light;
a polarizing beam splitter located in a light path of said laser beam from said light source, said polarizing beam splitter having characteristics of mainly transmitting p-polarized light and reflecting off s-polarized light toward a disc surface;
an APC photosensor element adapted to receive and detect p-polarized light transmitted through said polarizing beam splitter for use in controlling intensity of said laser beam; and
a data recording/reproducing photosensor element adapted to receive return light of said s-polarized light by way of said polarizing beam splitter from said disc surface for detection of signals.

2. An optical data recording/reproducing device as defined in claim 1, wherein said light source includes a light emitting element to project a linearly polarized light in reference to said polarizing beam splitter, said light emitting element being rotated about an optical axis through a predetermined angle to project a laser beam containing s-polarized light as a major component along with a minor proportion of p-polarized light.

3. An optical data recording/reproducing device as defined in claim 1, wherein said light source is so located as to project a laser beam in a direction parallel with said disc surface, s-polarized light component of said laser beam being reflected off toward said disc surface by said polarizing beam splitter.

4. An optical data recording/reproducing device as defined in claim 1, wherein said polarizing beam splitter has characteristics of substantially transmitting p-polarized light and reflecting off s-polarized light in a wavelength range of 375 nm to 830 nm.

5. An optical data recording/reproducing device as defined in claim 1, wherein a ¼ wave plate and an objective lens are located in a light path between said polarizing beam splitter and said optical disc in that order, and a diffraction element is located in a light path between said light source and said objective lens.

6. An optical data recording/reproducing device as defined in claim 5, further comprising a collimator lens located in a light path between said light source and said objective lens.

7. An optical data recording/reproducing device as defined in claim 1, wherein said light source is a holographic laser light source in the form of a unitary assembly incorporating with said data recording and reproducing photosensor element, and said diffraction element for splitting a light path of said laser beam.

8. An optical data recording/reproducing device as defined in claim 7, wherein said polarizing beam splitter and said holographic laser light source are joined together as an integral unit.
